(19) United States
(12) Patent Application Publication
(10) Pub. No.: US 2023/0065433 A1
(43) Pub. Date: Mar. 2, 2023

(54) IMAGE PROCESSING METHOD AND APPARATUS, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Xiao LI, Beijing (CN); Yibing MA, Beijing (CN); Chongyang MA, Beijing (CN)

(21) Appl. No.: 18/049,152

(22) Filed: Oct. 24, 2022

Related U.S. Application Data
(63) Continuation of application No. PCT/CN2020/129799, filed on Nov. 18, 2020.

(30) Foreign Application Priority Data
Apr. 28, 2020 (CN) 202010351704.9

(51) Int. Cl. G06T 7/13; G06T 7/73; G06T 11/20; G06V 10/82; G06V 40/10

(52) U.S. Cl. CPC G06T 7/13; G06T 7/74; G06T 11/203; G06V 10/82; G06V 40/10; G06T 2207/20084; G06T 2207/30196; G06T 2207/20076

(57) ABSTRACT

A method for processing an image, an electronic device and a storage medium are provided. The method includes: obtaining an original image including a target object; obtaining an auxiliary line by extracting semantic information from the original image, the auxiliary line including at least one of: an area boundary line of the target object and a part contour line of the target object; obtaining a prediction result for a semantic line by inputting an image stitched from the auxiliary line and the original image to a predictive neural network, the auxiliary line guiding the predictive neural network to obtain the prediction result, the prediction result indicating a probability that a pixel in the original image is a pixel in the semantic line, the semantic line being used for rendering the target object; and obtaining the semantic line based on the prediction result for the semantic line.

### CROSS-REFERENCE TO RELATED APPLICATION

The present disclosure is a continuation application of International Application No. PCT/CN2020/129799, filed on Nov. 18, 2020, which claims priority to Chinese Patent Application No. 202010351704.9, filed on Apr. 28, 2020, the disclosure of which is hereby incorporated by reference in their entireties.

### TECHNICAL FIELD

The present disclosure relates to the field of image processing and, in particular, to a method for processing an image, apparatus, electronic device and storage medium.

### BACKGROUND

Line extraction, a technique for transforming and processing digital images to abstract the contour and boundary information of the main objects in the scene described by the digital images, is widely used in various entertaining information production to bring a new experience to users. For example, the human portrait line extraction function is brought into the smartphone short video applications (APPs) to quickly achieve stylized rendering of human portrait photos.

However, among the lines extracted by the relevant line extraction techniques, the semantics of the lines used to identify the contour of the human portrait is poor, such as discontinuous lines, too fine and messy lines, etc., by which the human portrait cannot be well presented, resulting in poor user perception.

### SUMMARY

The present disclosure provides a method for processing an image, electronic device, and storage medium. The technical solution of the present disclosure is as follows.

According to a first aspect of the embodiments of the present disclosure. There is provided a method for processing an image. The method for processing the image includes: after obtaining an original image including a target object, obtaining an auxiliary line by extracting semantic information from the original image, the auxiliary line including at least one of: an area boundary line of the target object and a part contour line of the target object; obtaining a prediction result for a semantic line by inputting an image stitched from the auxiliary line and the original image to a predictive neural network, where the auxiliary line guides the predictive neural network to obtain the prediction result, the prediction result indicates a probability that a pixel in the original image is a pixel in the semantic line, and the semantic line is used for rendering the target object; and obtaining the semantic line based on the prediction result for the semantic line.

According to a second aspect of the embodiments of the present disclosure, there is provided an electronic device. The electronic device includes a processor and a memory for storing instructions executable by the processor. The processor is configured to execute the instructions to implement the method for processing the image as described in the first aspect above or in any of the possible embodiments of the first aspect.

According to a third aspect of the present disclosure, there is provided a non-transitory computer-readable storage medium on which instructions are stored that, when executed by a processor, implement the method for processing the image as described in the first aspect above or in any of the possible embodiments of the first aspect.

According to a fourth aspect of the present disclosure, there is provided a computer program product that, when instructions in the computer program product are executed by a processor of an electronic device, enables the electronic device to perform the method for processing the image as described in the first aspect above or in any of the possible embodiments of the first aspect.

It should be understood that the above general description and the following detailed description are merely exemplary and explanatory, and cannot limit the present disclosure.

### BRIEF DESCRIPTION OF THE DRAWINGS

The accompanying drawings herein, incorporated into and form part of the specification, illustrate embodiments consistent with the present disclosure, and are used with the specification to explain the principles of the present disclosure, and do not constitute an undue limitation of the present disclosure.

FIG. 1 is a schematic diagram of an interface of an application scenario illustrated according to an exemplary embodiment.

FIG. 2 is a flow chart of a method for processing an image illustrated according to an exemplary embodiment.

FIG. 3 is a schematic diagram of an example of an image processing process illustrated according to an exemplary embodiment.

FIG. 4 is a schematic diagram of an example of an image processing process illustrated according to an exemplary embodiment.

FIG. 5 is a flow chart of a method for processing an image illustrated according to an exemplary embodiment.

FIG. 6 is a schematic diagram of an example of an image processing process illustrated according to an exemplary embodiment.

FIG. 7 is a schematic diagram of an example of an image processing process illustrated according to an exemplary embodiment.

FIG. 8 is a flow chart of a method for processing an image illustrated according to an exemplary embodiment.

FIG. 9 is a flow chart of a method for processing an image illustrated according to an exemplary embodiment.

FIG. 10 is a schematic diagram of an example of an image processing process illustrated according to an exemplary embodiment.

FIG. 11 is a block diagram of an apparatus for processing an image illustrated according to an exemplary embodiment.

FIG. 12 is a block diagram of an apparatus for processing an image illustrated according to an exemplary embodiment.

FIG. 13 is a structural block diagram of an electronic device illustrated according to an exemplary embodiment.

### DETAILED DESCRIPTION

In order to enable those of ordinary skill in the art to better understand the technical solutions of the present disclosure, the technical solutions in the embodiments of the present disclosure will be clearly and completely described below in conjunction with the accompanying drawings.

It should be noted that the terms “first”, “second”, etc. in the specification, claims and the above accompanying drawings of the present disclosure are used to distinguish similar objects and not necessarily used to describe a particular order or sequence. It should be understood that the term so used may be interchanged, where appropriate, so that embodiments of the present disclosure described herein can be implemented in an order other than those illustrated or described herein. The implementations described in the following exemplary embodiments do not represent all embodiments that are consistent with the present disclosure. Rather, they are only examples of devices and methods that are consistent with some aspects of the present disclosure, as detailed in the appended claims.

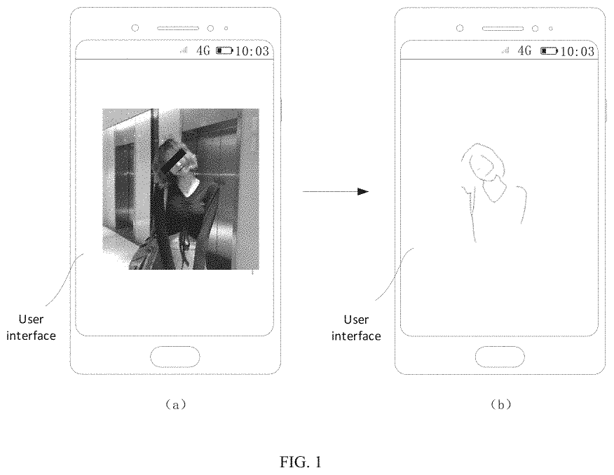

The method for processing the image provided by embodiments of the present disclosure can be applied in scenarios such as stylized rendering of human portraits. First, the electronic device determines an original image to be stylized for rendering. The original image includes an image of a target object. Here, the image of the target object may be a human portrait, as shown in (a) of FIG. 1. The original image can be a photo taken by the user or a frame from a video clip played by the cell phone. The electronic device uses a pre-trained predictive neural network to extract lines from the original image to obtain the lines used to identify the contour of the human portrait, as shown in (b) of FIG. 1, thus realizing the stylized rendering of the human portrait. The pre-trained predictive neural network can be a deep convolutional neural network, which obtains the lines to be extracted by performing a function transformation on the input original image. Here, the pre-trained predictive neural network is a complex nonlinear transform function, usually compounded by a series of convolution operators, activation functions, upsampling functions and downsampling functions, etc. For human portraits, the human portrait contours and the contours of the five senses have strong semantic information. However, in the related line extraction techniques, the pre-trained predictive neural network does not consider the semantic information of the target object to be extracted, and only relies on the input original image for prediction. Therefore, in the lines output by the pre-trained predictive neural network, the semantics of the lines are poor. For example, the lines used to identify the contour of the human portrait are discontinuous and too fragmented, which leads to poor user perception. In order to solve the problem of poor semantics of extracted lines in related line extraction techniques, embodiments of the present disclosure provide a method for processing image that can improve the semantics of lines in line extraction results and help to enhance the user's perception experience.

In some embodiments, an electronic device or server is used to implement the method for processing the image provided by embodiments of the present disclosure. The electronic device may be configured with a camera device, a display device, etc. In some embodiments, the electronic device may be a cell phone, a tablet computer, a laptop computer, a desktop computer, a portable computer, and other devices. In some embodiments, the server may be a single server, alternatively, may be a cluster of servers composed of multiple servers, without limitation in the present disclosure.

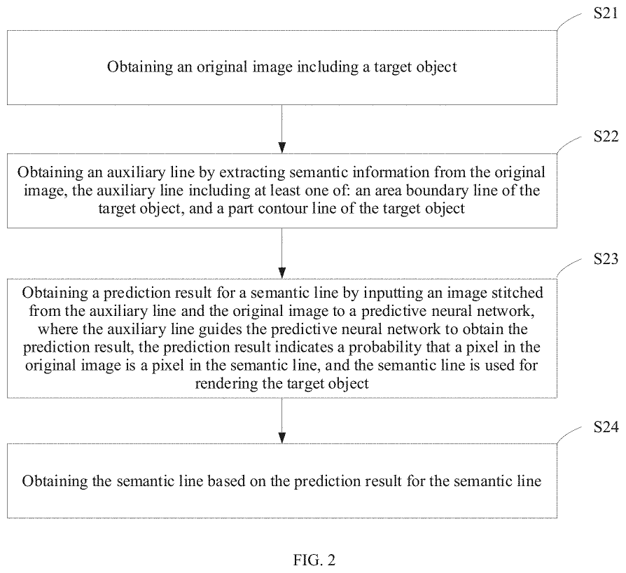

FIG. 2 is a flow chart of a method for processing an image illustrated according to an exemplary embodiment. In some embodiments, the method for processing the image may be applied to the electronic device and similar devices.

In S21, an original image including a target object is obtained.

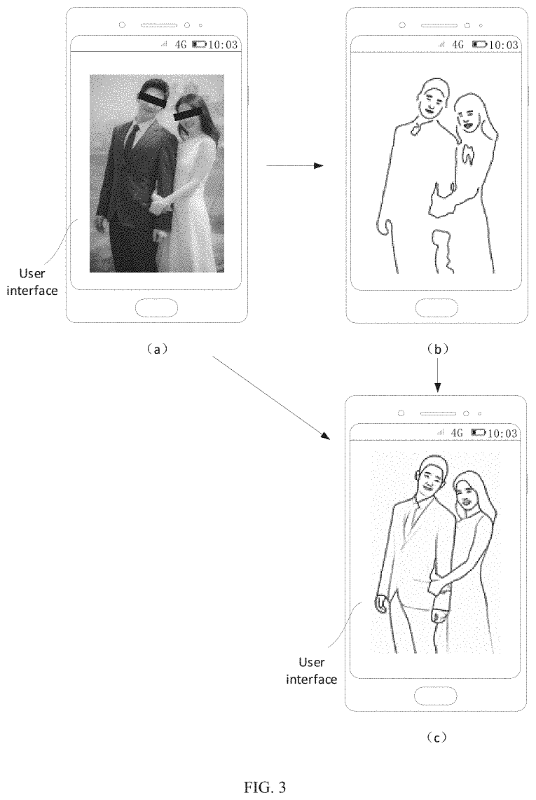

Here, the original image of the target object can be a human portrait, as shown in (a) of FIG. 3. In some embodiments, the original image can be a photo taken by the user or a frame from a video clip played by the cell phone.

In S22, an auxiliary line is obtained by extracting semantic information from the original image.

The semantic information can reflect the properties or characteristics of the target object. The auxiliary lines possess semantic information of the target object, specifically presented by area boundary lines of the target object and/or part contour lines of the target object.

In some embodiments, for a human portrait, the semantic information may be human body features, hair features, clothing features, etc. in the human portrait. Accordingly, the auxiliary lines can be the area boundary lines of the human portrait, such as the boundary lines of the human body area, the boundary lines of the hair area, or the boundary lines of the clothing area, etc. The semantic information can also be the features of the five senses in the human portrait, etc. Accordingly, the auxiliary lines can be the part contour lines of the human portrait, such as face contour lines, eye contour lines, nose contour lines or mouth contour lines. Referring to (b) of FIG. 3, the auxiliary lines are the lines in the binarized image.

In S23, a prediction result is obtained for a semantic line by inputting an image stitched from the auxiliary line and the original image to a predictive neural network.

The auxiliary lines are used to guide the predictive neural network to obtain the prediction results of the semantic lines. The prediction results for the semantic lines are used to indicate the probabilities that the pixels in the original image are the pixels in the semantic lines. In practical applications, the prediction results for the semantic lines can be specifically implemented as line probability maps. The semantic lines are used to render the target object as shown in (c) of FIG. 3.

The predictive neural network is pre-trained. The predictive neural network can be a deep convolutional neural network, including a convolutional layer, a downsampling layer, and a deconvolutional layer, supporting original or raw images of arbitrary resolution. The predictive neural network can also be other convolutional neural networks.

In some embodiments, the auxiliary lines may be presented by binarizing the image. The binarized image presenting the auxiliary lines is stitched with the original image to obtain a four-channel input image, which is fed to the predictive neural network as the stitched image. Here, the original image is a color image, which is input through three channels, i.e., red (R), blue (B), and green (G). The fourth channel is used for the input of the binarized image that presents the auxiliary lines. Based on the semantic information of the auxiliary lines, the predictive neural network uses the semantic information as a constraint to predict the original image to obtain the prediction results for the semantic lines. Combined with (b) and (c) of FIG. 3, the predictive neural network predicts the finger boundary lines based on the boundary lines of the human body area, enriching the details of part of the human body, etc. The predictive neural network, based on the boundary lines of the clothing area, predicts the collar boundary lines, the clothing corner boundary lines, etc., enriching the details of the clothing part, etc.

In S24, the semantic line is obtained based on the prediction result for the semantic line.

In some embodiments, obtaining the semantic line based on the prediction result for the semantic line may include: binarizing a line probability map based on the line probability map as the prediction result for the semantic line with a certain threshold value to obtain a binarized image. The lines in the binarized image are the semantic lines to render the target object. The threshold value used in the binarization processing can be 0.5.

In some embodiments, obtaining the semantic line based on the prediction result for the semantic line may further include: first, performing a high-contrast retention process on the line probability map to obtain a high-contrast probability map to achieve the effect of filtering and noise reduction, which helps to improve the robustness of the semantic lines; and then binarizing the high-contrast probability map to obtain the binarized image. The lines in the binarized image are the semantic line to render the target object. The high-contrast probability map still indicates the probability that a pixel in the original image is a pixel in the semantic line.

Here, the relationship between the line probability map and the high-contrast probability map satisfies the following equation.

E_{raw-high}=E_{raw}−G(E_{raw})=0.5 Equation (1).

Here, E_{raw-high} represents the high-contrast probability map, E_{raw} represents the line probability map, and G(E_{raw}) represents Gaussian filtering operation on the line probability map.

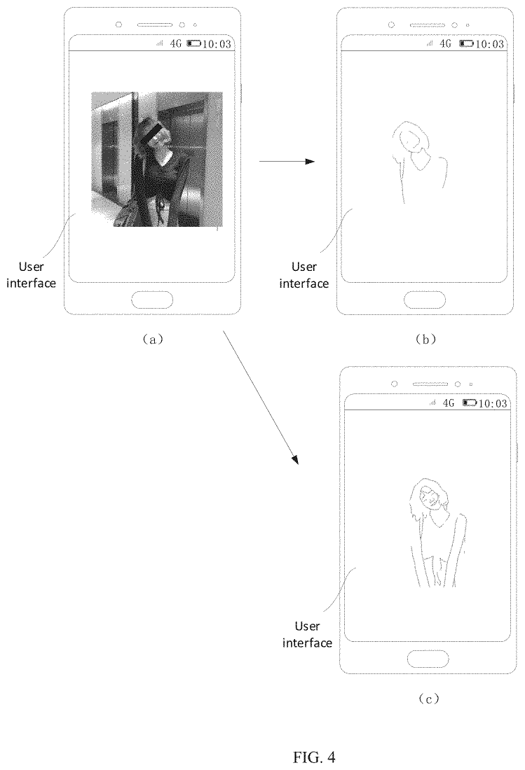

FIG. 4 is a schematic diagram of an example of an image processing process illustrated according to an exemplary embodiment. For the original image shown in (a) of FIG. 4, the lines obtained based on existing line extraction techniques for identifying the contour of the human portrait are discontinuous, as shown in (b) of FIG. 4. The semantic lines, obtained based on the method for processing the image provided in the embodiments of this disclosure, are shown in (c) of FIG. 4. Compared with (b) in FIG. 4, the semantic lines used to identify the contour of the human portrait in (c) of FIG. 4 have stronger semantics, the semantic lines are more coherent, and the features of the five senses, the contour of the human body, the contour of the hair and the contour of the clothing of the human portrait can be presented relatively clearly, and the image has a good perception effect.

The method for processing the image provided by the embodiments of the present disclosure enables the semantic lines to be more semantic. Thus, the semantic lines used to identify the contour of the target object are more coherent, and the possibility of the semantic lines being too fine is lower, which helps to improve the user's perception effect.

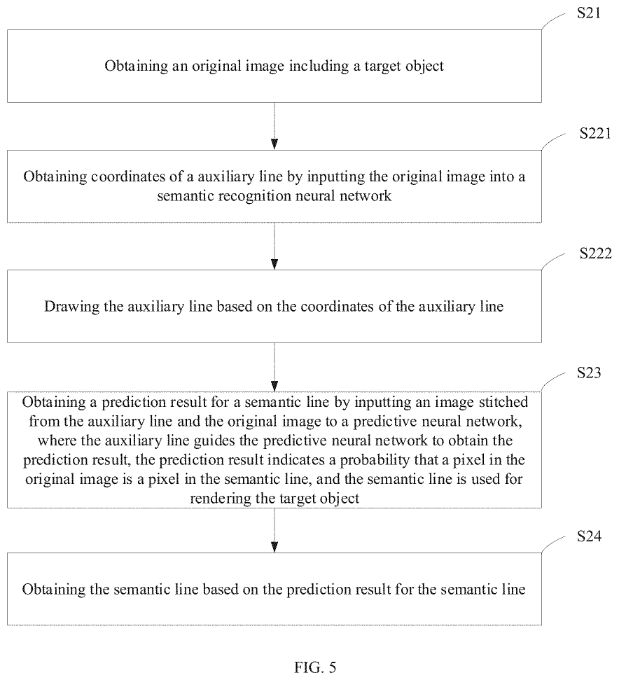

FIG. 5 is a flow chart of a method for processing an image illustrated according to an exemplary embodiment.

In S221, coordinates of the auxiliary line are obtained by inputting the original image into a semantic recognition neural network.

The semantic recognition neural network is pre-trained. There are various types of the semantic recognition neural network. In the case where the original image of the target object is a human portrait, the semantic recognition neural network can be, for example, but not limited to: a human body segmentation neural network, a hair segmentation neural network, a clothing segmentation neural network, a part contour recognition neural network, etc.

There are various types of the auxiliary line. For the original image of the target object is a human portrait, the auxiliary lines may be, for example, but not limited to: a boundary line of a body area, a boundary line of a hair area, a boundary line of a clothing area, a contour line of a face, a contour line of eyes, a contour line of a nose, and a contour line of a mouth, and the like. Here, the boundary line of the body area, the boundary line of the hair area, and the boundary line of the clothing area are the area boundary lines; the contour line of the face, the contour line of the eyes, the contour line of the nose, and the contour line of the mouth are the part contour lines. The specific implementation process of S221 is explained in the following three cases.

For case I, the auxiliary lines include the area boundary lines. In the method for processing the image of the embodiments of this disclosure, the coordinates of the area boundary line are obtained by step 1 and step 2. In particular, step 1 and step 2 are described as follows.

In step 1, the original image is input into the area segmentation neural network to obtain the area segmentation probability maps for different areas.

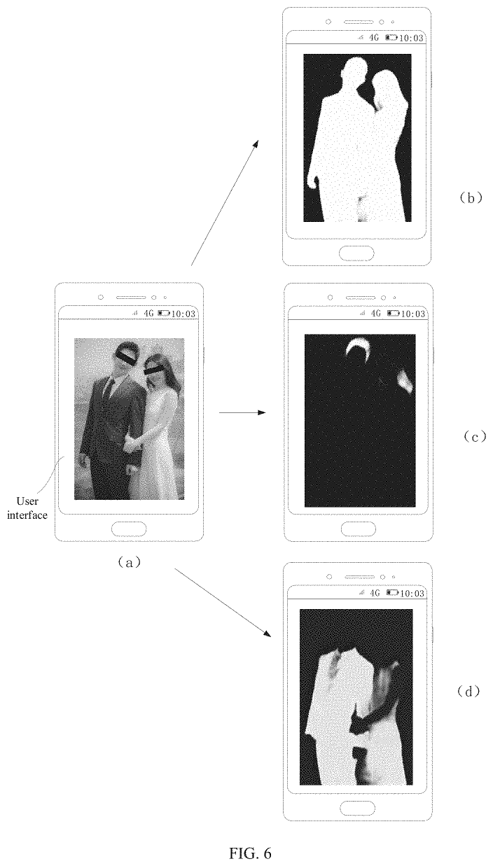

The area segmentation neural network is used to perform area segmentation on the original image. The area segmentation neural network can be the human body segmentation neural network, the hair segmentation neural network, the clothing segmentation neural network, etc., as described above. An area segmentation probability map of an area is used to indicate the probability that different pixels in the original image belong to the corresponding area. In some embodiments, the original image is shown as (a) of FIG. 6.

The human body segmentation neural network is used for area recognition of the original image, and the probability that different pixels in the original image belong to the pixels in the human body area is calculated to obtain the human body area segmentation probability map, as shown in (b) of FIG. 6. The human body area segmentation probability map is consistent with the original image in size, and the higher the brightness of the location characterizes the higher the probability that the location belongs to the human body area.

The hair segmentation neural network is used for area identification of the original image, and the probability of different pixels in the original image belonging to the pixels in the hair area is calculated to obtain the hair area segmentation probability map, as shown in (c) of FIG. 6. The hair area segmentation probability map is consistent with the original image in size, and the higher the brightness of the location characterizes the higher the probability that the location belongs to the hair area.

The clothing segmentation neural network is used for area recognition of the original image, and the probability of different pixels in the original image belonging to the pixels in the clothing area is calculated to obtain the clothing area segmentation probability map, as shown in (d) of FIG. 6. The clothing area segmentation probability map is consistent with the original image in size, and the higher the brightness of the location characterizes the higher the probability that the location belongs to the clothing area.

In step 2, the coordinates of the area boundary lines are obtained based on the area segmentation probability maps of different areas.

In some embodiments, since the human body area segmentation probability map can indicate the probability of different pixels belonging to the human body area, based on the human body area segmentation probability map, the human body area segmentation probability map is first binarized to obtain the binarized image of the human body area. Then, a predefined processing function, e.g., open source computer vision library (OpenCV) function, is used to extract the boundary of the binarized image of the human body area and obtain the coordinates of the boundary line of the human body area. In this case, the threshold value for the binarization can be 0.5.

The hair area segmentation probability map is processed similarly to obtain the coordinates of the boundary line of the hair area. The same processing is performed on the clothing area segmentation probability map to obtain the coordinates of the boundary line of the clothing area. In this case, a same threshold or different thresholds can be used for binarizing different area segmentation probability maps, which is not limited by the embodiments of this application.

For case II, the auxiliary lines include the part contour lines. In the method for processing the image of the embodiments of this disclosure, the coordinates of the part contour line are obtained by performing the following processes.

The original image is input into the part contour recognition neural network to identify the part contour points of different parts and obtain the coordinates of the part contour lines.

The part contour points of a part are used to present the contour of this part.

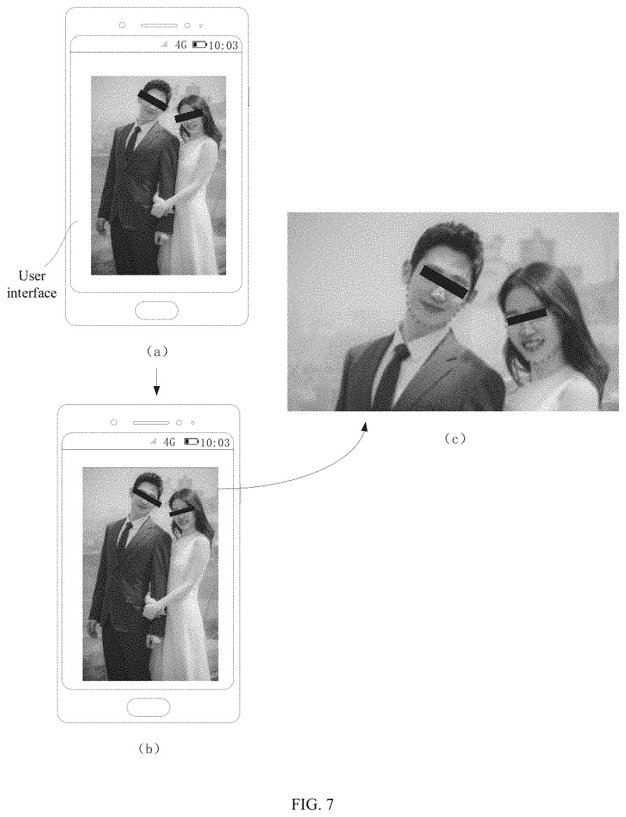

In some embodiments, the original image is shown in (a) of FIG. 7. The part contour recognition neural network is used to recognize the original image, and the original image with part contour points distributed is obtained, the part contour points being mainly distributed in the face of the human portrait, as shown in (b) of FIG. 7. The enlarged image of the face in (b) of FIG. 7 is shown in (c) of FIG. 7. The part contour points of the face, such as the face contour points, the eye contour points, the nose contour points, and the mouth contour points, are shown in (c) of FIG. 7.

For case III, the auxiliary lines include the area boundary lines and part contour lines. The process of obtaining the coordinates of the auxiliary lines can be found in the relevant descriptions for case I and case II and will not be repeated here.

In S222, the auxiliary line is drawn based on the coordinates of the auxiliary line.

In some embodiments, an open graphics library (Open GL) shader is used to draw the complete auxiliary lines based on the coordinates of the auxiliary lines.

In this way, the coordinates of different auxiliary lines are identified by the semantic recognition neural network, and then the auxiliary lines are drawn based on the coordinates of the auxiliary lines, so that the integration of the auxiliary lines, such as the integration of different area boundary lines and/or different part contour lines in the same binarized image, can be achieved.

In addition, in the case where the auxiliary lines include the area boundary lines, a deep learning method can also be used to perform area segmentation on the original image to obtain the area boundary lines. Similarly, in the case where the auxiliary lines include the part contour lines, a deep learning method can also be used to recognize the part contour points on the original image to obtain the part contour lines.

In some embodiments, in the case where the auxiliary lines include the part contour lines, the method for processing the image of the embodiments of the present disclosure further includes step 3 and step 4.

In step 3, a category to which features of a target part belong is determined.

In some embodiments, in the case where the original image of the target object is a human portrait, and the target part being an eye, the type to which the feature of the eye belongs can be a single eyelid or a double eyelid. The original image is recognized using an eyelid type detection neural network to obtain the categories of the left and right eyes in the human portrait, i.e., whether the left eye in the human portrait belongs to single or double eyelid, and whether the right eye in the human portrait belongs to single or double eyelid.

When the target part is a mouth, the type to which the features of the mouth belong can be a upward crescent moon shape, downward crescent moon shape, “IN” shape, or “—” shape, etc. The mouth type detection neural network is used to recognize the original image and obtain the category of the mouth type in the human portrait, i.e., which type of the mouth type in the human portrait belongs to the upward crescent moon shape, downward crescent moon shape, “IN” shape, or shape.

In step 4, the contour line of the target part is adjusted according to the category to which the feature of the target part belongs.

In some embodiments, based on the type to which the eye feature belongs is double eyelid, a double eyelid curve is added on top of the eye contour line. Based on the type to which the features of the mouth belong is the upward crescent moon shape, the angle or shape of the corners of the mouth is adjusted based on the contour line of the mouth.

In this way, when the semantic lines include the part contour line of the target part, it is also possible to adjust the part contour line of the corresponding target part based on the type to which the features of the target part belong, so that the auxiliary lines have more semantic information. In this way, when predicting based on the adjusted part contour line of the target part, the semantic lines obtained are more semantic, making the semantic lines more complete and coherent to render the target object in a more comprehensive manner.

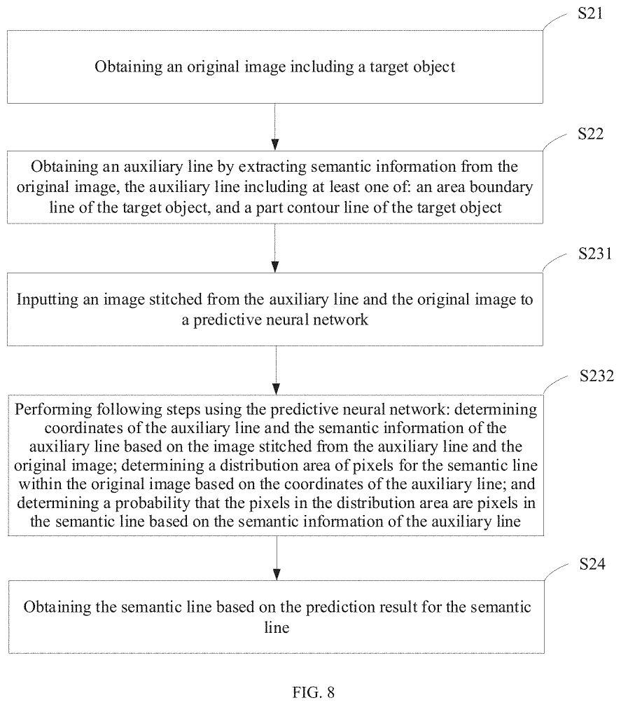

FIG. 8 is a flow chart of a method for processing an image illustrated according to an exemplary embodiment.

In S231, the image, stitched from the auxiliary line and the original image, is input to the predictive neural network.

The auxiliary lines are presented by binarizing the image, and the lines in the binarized image are the auxiliary lines. The binarized image used to present the auxiliary lines is of the same size as the original image. The description of the auxiliary lines, the predefined neural network and the stitched image can be found in S23 and will not be repeated here.

In S232, the predictive neural network is used to perform the following steps: determining coordinates of the auxiliary line and the semantic information of the auxiliary line based on the image stitched from the auxiliary line and the original image; determining a distribution area of pixels for the semantic line within the original image based on the coordinates of the auxiliary line; and determining a probability that the pixels in the distribution area are pixels in the semantic line based on the semantic information of the auxiliary line.

In some embodiments, a closed region can be determined based on the coordinates of the auxiliary lines, and the predictive neural network is expanded outward with the center point of the closed region according to predetermined values to obtain the distribution areas of the pixels in the semantic lines in the original image.

Here, the coordinates of the auxiliary lines can indicate the distribution areas of the semantic lines for the predictive neural network, which in turn enables the predictive neural network to determine the pixels of the semantic lines in the distribution areas of the semantic lines in order to improve the prediction efficiency. Moreover, the semantic information of the auxiliary lines can reflect the attributes or features of the semantic lines to enable the predictive neural network to more accurately identify the pixels in the semantic lines to improve the prediction accuracy.

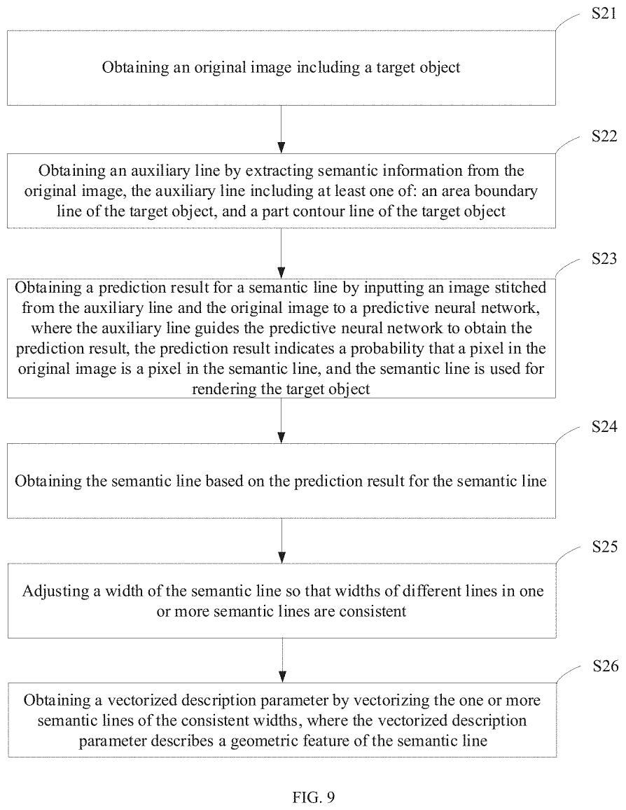

In some embodiments, in the method for processing the image in the embodiments of the present disclosure, after obtaining the semantic lines, the semantic lines can also be optimized. FIG. 9 is a flow chart of a method for processing an image illustrated according to an exemplary embodiment.

In S25, a width of the semantic line is adjusted so that widths of different lines in one or more semantic lines are consistent.

In some embodiments, the semantic lines may be the lines after binarization of a high-contrast probability map. The high-contrast probability map still indicates the probability that a pixel in the original image is a pixel in the semantic line.

In the case where a preset width value is set, the pixels to be deleted in the semantic lines are marked according to the preset width value, and then the marked pixels are deleted. In this way, a skeleton of the semantic lines is obtained so that the semantic lines are refined to be of the preset width. Here, the preset width value may be the data set by the user. The preset width value may be the width value of a certain number of pixels. Zhang-Suen parallel thinning algorithm can be used to adjust the width of the semantic lines.

In S26, obtaining a vectorized description parameter by vectorizing the one or more semantic lines of the consistent widths.

The vectorized description parameters are used to describe the geometric characteristics of the semantic lines. For example, for a curve, the geometric characteristics can be the center of the circle, angle, radius, etc. of that curve.

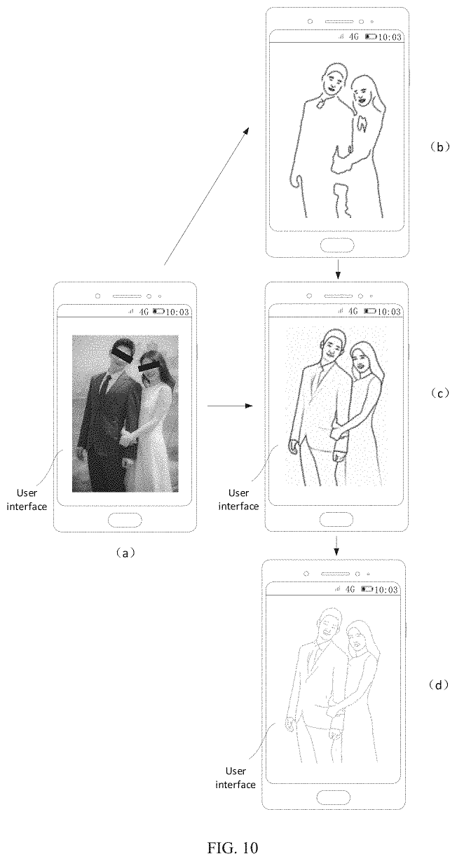

In some embodiments, the algorithm for performing the vectorization process may be the Potrace vectorization algorithm, and the vectorization expression parameters for the semantic lines may be Quadratic Bézier curve expression parameters. The semantic lines indicated by the vectorization expression parameters are resolution independent and are stored in scalable vector graphics (SVG) format, which can be rendered to the display screen by any application for display on the display screen. Referring to FIG. 10, (a) of FIG. 10 shows the original image including the human portrait that is the same as the original image shown in FIG. 3; (c) of FIG. 10 shows the human portrait rendered by semantic lines; and (d) of FIG. 10 shows the image after optimization process, and in (d) of FIG. 10, the semantic lines have the same width.

In this way, the widths of the semantic lines are consistent, and using the vectorized description parameters to describe the geometric characteristics of the semantic lines, makes the widths of the semantic lines more controllable, and allows the semantic lines of consistent widths to be presented at different resolutions, so as to enhance the user's perception effect and avoid the problem of “affecting the overall style of the image due to the inconsistent width of the lines” in the related art.

In addition, the method for processing the image according to the embodiments of the present disclosure has high processing efficiency. Based on the resolution of the original image being 512*512, it takes 1 second to complete the calculation of all the steps of the above method for processing the image.

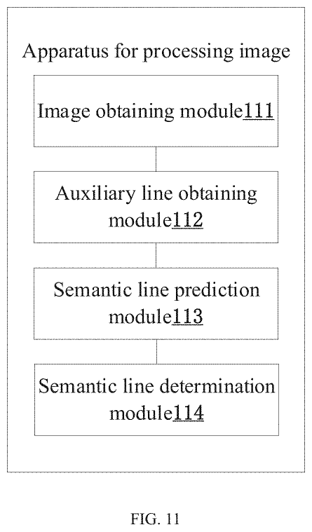

FIG. 11 is a block diagram of an apparatus for processing an image illustrated according to an exemplary embodiment. The apparatus includes an image obtaining module 111, an auxiliary line obtaining module 112, a semantic line prediction module 113, and a semantic line determination module 114.

The image obtaining module 111 is configured to obtain an original image including a target object.

The auxiliary line obtaining module 112 is configured to obtain an auxiliary line by extracting semantic information from the original image, the auxiliary line including at least one of: an area boundary line of the target object and a part contour line of the target object.

The semantic line prediction module 113 is configured to obtain a prediction result for a semantic line by inputting an image stitched from the auxiliary line and the original image to a predictive neural network, where the auxiliary line guides the predictive neural network to obtain the prediction result, the prediction result indicates a probability that a pixel in the original image is a pixel in the semantic line, and the semantic line is used for rendering the target object.

The semantic line determination module 114 is configured to obtain the semantic line based on the prediction result for the semantic line.

In some embodiments, the auxiliary line obtaining module 112 is further configured to obtain coordinates of the auxiliary line by inputting the original image into a semantic recognition neural network. The auxiliary line obtaining module 112 is further configured to draw the auxiliary line based on the coordinates of the auxiliary line.

In some embodiments, the semantic line prediction module 113 is further configured to input the image stitched from the auxiliary line and the original image to the predictive neural network. The semantic line prediction module 113 is further configured to perform following steps using the predictive neural network: determining coordinates of the auxiliary line and the semantic information of the auxiliary line based on the image stitched from the auxiliary line and the original image; determining a distribution area of pixels for the semantic line within the original image based on the coordinates of the auxiliary line; and determining a probability that the pixels in the distribution area are pixels in the semantic line based on the semantic information of the auxiliary line.

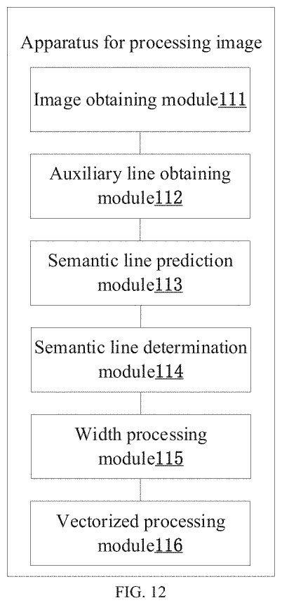

In some embodiments, FIG. 12 is a block diagram of an apparatus for processing an image illustrated according to an exemplary embodiment. The apparatus for processing the image further includes a width processing module 115 and a vectorized processing module 116.

The width processing module 115 is configured to adjust a width of the semantic line so that widths of different lines in one or more semantic lines are consistent.

The vectorized processing module 116 is configured to obtain a vectorized description parameter by vectorizing the one or more semantic lines of the consistent widths, where the vectorized description parameter describes a geometric feature of the semantic line.

In some embodiments, an image of the target object is a human portrait. In a case that the auxiliary line includes the area boundary line, the area boundary line includes at least one of: a boundary line of a body area, a boundary line of a hair area, and a boundary line of a clothing area. In a case that the auxiliary line includes the part contour line, the part contour line includes at least one of: a contour line of a face, a contour line of eyes, a contour line of a nose, and a contour line of a mouth.

Regarding the apparatus in the above embodiments, the specific way in which each module performs its operation has been described in detail in the embodiments concerning the method, and will not be described in detail here.

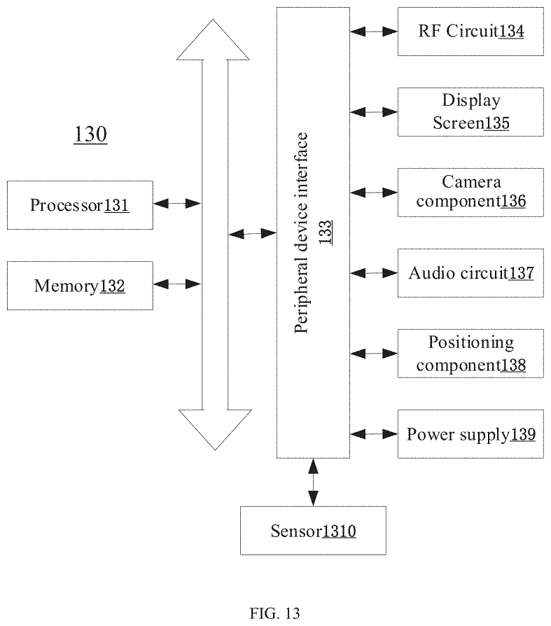

When the apparatus for processing the image is an electronic device, FIG. 13 illustrates a schematic diagram of one possible structure of the electronic device. As shown in FIG. 13, the electronic device 130 includes a processor 131 and a memory 132.

It should be understood that the electronic device 130 shown in FIG. 13 may implement all of the functions of the apparatus for processing the image described above. The functions of the individual modules of the above apparatus for processing image can be implemented in the processor 131 of the electronic device 130. The memory unit of the apparatus for processing the image (not shown in FIGS. 11 and 12) is equivalent to the memory 132 of the electronic device 130.

The processor 131 may include one or more processing cores, such as a 4-core processor, an 8-core processor, etc. The processor 131 may include an application processor (AP), a modem processor, a graphics processing unit (GPU), an image signal processor (ISP), a controller, a memory, a video codec, digital signal processor (DSP), baseband processor, and/or neural-network processing unit (NPU), etc. Among them, the different processing units can be standalone devices or integrated in one or more processors.

Memory 132 may include one or more computer-readable storage media, which may be non-transitory. Memory 132 may also include high-speed random access memory, and non-volatile memory, such as one or more disk storage devices, flash memory storage devices. In some embodiments, the non-transitory computer-readable storage medium in memory 132 is used to store at least one instruction that is used to be executed by processor 131 to implement the method for processing the image provided by the method embodiments of the present application.

In some embodiments, the electronic device 130 optionally also includes: a peripheral device interface 133 and at least one peripheral device. The processor 131, the memory 132, and the peripheral device interface 133 may be connected to each other via a bus or signal line. Each peripheral device may be connected to the peripheral device interface 133 via a bus, signal line, or circuit board. Specifically, the peripheral devices include at least one of: an RF circuit 134, a display screen 135, a camera component 136, an audio circuit 137, a positioning component 138, and a power supply 139.

The peripheral device interface 133 may be used to connect at least one peripheral device related to input/output (I/O) to the processor 131 and the memory 132. In some embodiments, the processor 131, the memory 132, and the peripheral device interface 133 are integrated on the same chip or board; in some other embodiments, any one or two of the processor 131, the memory 132, and the peripheral device interface 133 may be implemented on separate chips or boards, which are not limited by this embodiment.

The RF circuit 134 is used to receive and transmit radio frequency (RF) signals, also known as electromagnetic signals. The RF circuit 134 communicates with communication networks and other communication devices via electromagnetic signals. The RF circuit 134 converts electrical signals to electromagnetic signals for transmission, or, converts received electromagnetic signals to electrical signals. Optionally, the RF circuit 134 includes: an antenna system, an RF transceiver, one or more amplifiers, a tuner, an oscillator, a digital signal processor, a codec chipset, a user identity module card, and the like. The RF circuit 134 may communicate with other electronic devices via at least one wireless communication protocol. The wireless communication protocols include, but are not limited to, metropolitan area networks, various generations of mobile communication networks (2G, 3G, 4G, and 5G), wireless local area networks, and/or wireless fidelity (Wi-Fi) networks. In some embodiments, The RF circuit 134 may also include the circuit related to near field communication (NFC), which is not limited by the present disclosure.

The display screen 135 is used to display a user interface (UI). The UI may include graphics, text, icons, video, and any combination thereof. When the display screen 135 is a touch display screen, the display screen 135 also has the ability to capture a touch signal on or above the surface of the display screen 135. This touch signal can be input to processor 131 for processing as a control signal. In this case, the display screen 135 can also be used to provide virtual buttons and/or a virtual keyboard, also referred to as soft buttons and/or a soft keyboard. In some embodiments, one display screen 135 may be provided on the front panel of the electronic device 130. The display screen 135 may be prepared using a material such as liquid crystal display (LCD), organic light-emitting diode (OLED), etc.

The camera component 136 is used to capture images or video. Optionally, the camera component 136 includes a front camera and a rear camera. Typically, the front camera is provided on the front panel of the electronic device 130 and the rear camera is provided on the back of the electronic device 130. The audio circuit 137 may include a microphone and a speaker. The microphone is used to capture sound waves from the user and the environment and convert the sound waves into electrical signals to be input to the processor 131 for processing or to the RF circuit 134 for voice communication. For stereo sound capture or noise reduction purposes, a plurality of microphones may be provided, each of which is provided in a different part of the electronic device 130. The microphones may also be array microphones or omnidirectional capture microphones. The speaker is then used to convert the electrical signal from the processor 131 or RF circuit 134 into sound waves. The speaker can be a conventional thin-film speaker or a piezoelectric ceramic speaker. When the speaker is a piezoelectric ceramic speaker, it is possible to convert electrical signals not only into human audible sound waves, but also into human inaudible sound waves for purposes such as ranging. In some embodiments, the audio circuit 137 may also include a headphone jack.

The positioning component 138 is used to locate the current geographic location of the electronic device 130 for navigation or location based service (LBS). The positioning component 138 may be a positioning component based on the global positioning system (GPS) of the United States, the BeiDou Navigation Satellite System of China, the Grenas system of Russia, or the Galileo system of the European Union.

The power supply 139 is used to power the various components in the electronic device 130. The power supply 139 may be alternating current (AC), direct current (DC), disposable batteries, or rechargeable batteries. When the power supply 139 includes a rechargeable battery, the rechargeable battery may support wired charging or wireless charging. The rechargeable battery may also be used to support fast charging technology.

In some embodiments, the electronic device 130 further includes one or more sensors 1310. The one or more sensors 1310 include, but are not limited to: an acceleration sensor, a gyroscope sensor, a pressure sensor, a fingerprint sensor, an optical sensor, and a proximity sensor.

The acceleration sensor can detect the magnitude of acceleration on the three axes of the coordinate system established with the electronic device 130. The gyroscope sensor can detect the body orientation and rotation angle of the electronic device 130 and the gyroscope sensor can work in concert with the acceleration sensor to capture 3D movements of the user on the electronic device 130. The pressure sensor can be set on the side bezel and/or lower layer of the display 135 of the electronic device 130. When the pressure sensor is provided on the side bezel of the electronic device 130, the user's grip signal on the electronic device 130 can be detected. The fingerprint sensor is used to capture the user's fingerprint. The Optical sensor is used to capture the intensity of ambient light. The proximity sensor, also known as a distance sensor, is typically set on the front panel of the electronic device 130. The proximity sensor is used to capture the distance between the user and the front of the electronic device 130.

The present disclosure also provides a computer-readable storage medium with instructions stored on the computer-readable storage medium that, when the instructions in the storage medium are executed by a processor of the electronic device, enable the electronic device to perform the method for processing the image provided in the embodiments of the present disclosure described above.

The present disclosure also provides a computer program product including instructions that, when the instructions in the computer program product are executed by a processor of an electronic device, cause the electronic device to perform the method for processing the image provided in the embodiments of the present disclosure described above.

Other embodiments of the present disclosure will readily occur to those skilled in the art upon consideration of the specification and practice of the invention disclosed herein. This application is intended to cover any variation, use, or adaptation of the present disclosure that follows the general principles of the present disclosure and includes commonly known or customary technical means in the art that are not disclosed herein. The description and embodiments are considered exemplary only, and the true scope and spirit of the disclosure is indicated by the following claims.

It should be understood that the present disclosure is not limited to the precise construction already described above and illustrated in the accompanying drawings, and that various modifications and changes may be made without departing from its scope. The scope of the present disclosure is limited only by the appended claims.

What is claimed is:

1. A method for processing an image, comprising:
obtaining an original image comprising a target object;
obtaining an auxiliary line by extracting semantic information from the original image, the auxiliary line comprising at least one of: an area boundary line of the target object and a part contour line of the target object;
obtaining a prediction result for a semantic line by inputting an image stitched from the auxiliary line and the original image to a predictive neural network, wherein the auxiliary line guides the predictive neural network to obtain the prediction result, the prediction result indicates a probability that a pixel in the original image is a pixel in the semantic line, and the semantic line is used for rendering the target object; and
obtaining the semantic line based on the prediction result for the semantic line.

2. The method of claim 1, wherein said obtaining an auxiliary line by extracting semantic information from the original image comprises:
obtaining coordinates of the auxiliary line by inputting the original image into a semantic recognition neural network; and
drawing the auxiliary line based on the coordinates of the auxiliary line.

3. The method of claim 1, wherein said obtaining a prediction result for a semantic line by inputting an image stitched from the auxiliary line and the original image to a predictive neural network, comprises:
inputting the image stitched from the auxiliary line and the original image to the predictive neural network; and
performing following steps using the predictive neural network:
determining coordinates of the auxiliary line and the semantic information of the auxiliary line based on the image stitched from the auxiliary line and the original image;
determining a distribution area of pixels for the semantic line within the original image based on the coordinates of the auxiliary line; and
determining a probability that the pixels in the distribution area are pixels in the semantic line based on the semantic information of the auxiliary line.

4. The method of claim 2, wherein said obtaining a prediction result for a semantic line by inputting an image stitched from the auxiliary line and the original image to a predictive neural network, comprises:
inputting the image stitched from the auxiliary line and the original image to the predictive neural network; and
performing following steps using the predictive neural network:
determining coordinates of the auxiliary line and the semantic information of the auxiliary line based on the image stitched from the auxiliary line and the original image;
determining a distribution area of pixels for the semantic line within the original image based on the coordinates of the auxiliary line; and
determining a probability that the pixels in the distribution area are pixels in the semantic line based on the semantic information of the auxiliary line.

5. The method of claim 1, further comprising:
adjusting a width of the semantic line so that widths of different lines in one or more semantic lines are consistent; and
obtaining a vectorized description parameter by vectorizing the one or more semantic lines of the consistent widths, wherein the vectorized description parameter describes a geometric feature of the semantic line.

6. The method of claim 2, further comprising:
adjusting a width of the semantic line so that widths of different lines in one or more semantic lines are consistent; and
obtaining a vectorized description parameter by vectorizing the one or more semantic lines of the consistent widths, wherein the vectorized description parameter describes a geometric feature of the semantic line.

7. The method of claim 1, wherein an image of the target object is a human portrait;
in a case that the auxiliary line comprises the area boundary line, the area boundary line comprises at least one of: a boundary line of a body area, a boundary line of a hair area, and a boundary line of a clothing area; and/or
in a case that the auxiliary line comprises the part contour line, the part contour line comprises at least one of: a contour line of a face, a contour line of eyes, a contour line of a nose, and a contour line of a mouth.

8. The method of claim 2, wherein an image of the target object is a human portrait;
in a case that the auxiliary line comprises the area boundary line, the area boundary line comprises at least one of: a boundary line of a body area, a boundary line of a hair area, and a boundary line of a clothing area; and/or
in a case that based on the auxiliary line comprises the part contour line, the part contour line comprises at least one of: a contour line of a face, a contour line of eyes, a contour line of a nose, and a contour line of a mouth.

9. An electronic device, comprising:
a processor; and
a memory for storing instructions executable by the processor;
wherein the processor is configured to execute the instructions to implement a method for processing an image; and
wherein the processor is configured to
obtain an original image comprising a target object;
obtain an auxiliary line by extracting semantic information from the original image, the auxiliary line comprising at least one of: an area boundary line of the target object and a part contour line of the target object;
obtain a prediction result for a semantic line by inputting an image stitched from the auxiliary line and the original image to a predictive neural network, wherein the auxiliary line guides the predictive neural network to obtain the prediction result, the prediction result indicates a probability that a pixel in the original image is a pixel in the semantic line, and the semantic line is used for rendering the target object; and
obtain the semantic line based on the prediction result for the semantic line.

10. The electronic device of claim 9, wherein the processor is configured to:
obtain coordinates of the auxiliary line by inputting the original image into a semantic recognition neural network; and
draw the auxiliary line based on the coordinates of the auxiliary line.

11. The electronic device of claim 9, wherein the processor is configured to:
input the image stitched from the auxiliary line and the original image to the predictive neural network; and
performing following steps using the predictive neural network:
determining coordinates of the auxiliary line and the semantic information of the auxiliary line based on the image stitched from the auxiliary line and the original image;
determining a distribution area of pixels for the semantic line within the original image based on the coordinates of the auxiliary line; and
determining a probability that the pixels in the distribution area are pixels in the semantic line based on the semantic information of the auxiliary line.

12. The electronic device of claim 10, wherein the processor is configured to:
input the image stitched from the auxiliary line and the original image to the predictive neural network; and
performing following steps using the predictive neural network:
determining coordinates of the auxiliary line and the semantic information of the auxiliary line based on the image stitched from the auxiliary line and the original image;
determining a distribution area of pixels for the semantic line within the original image based on the coordinates of the auxiliary line; and
determining a probability that the pixels in the distribution area are pixels in the semantic line based on the semantic information of the auxiliary line.

13. The electronic device of claim 9, wherein the processor is further configured to:
adjust a width of the semantic line so that widths of different lines in one or more semantic lines are consistent; and
obtain a vectorized description parameter by vectorizing the one or more semantic lines of the consistent widths, wherein the vectorized description parameter describes a geometric feature of the semantic line.

14. The electronic device of claim 10, wherein the processor is further configured to:
adjust a width of the semantic line so that widths of different lines in one or more semantic lines are consistent; and
obtain a vectorized description parameter by vectorizing of the one or more semantic lines of the consistent widths, wherein the vectorized description parameter describes a geometric feature of the semantic line.

15. The electronic device of claim 9, wherein an image of the target object is a human portrait;
in a case that the auxiliary line comprises the area boundary line, the area boundary line comprises at least one of: a boundary line of a body area, a boundary line of a hair area, and a boundary line of a clothing area; and/or
in a case that the auxiliary line comprises the part contour line, the part contour line comprises at least one of: a contour line of a face, a contour line of eyes, a contour line of a nose, and a contour line of a mouth.

16. A non-transitory computer-readable storage medium, enabling an electronic device to perform a method for processing an image when instructions in the storage medium are executed by a processor of the electronic device, wherein the method for processing the image comprises:
obtaining an original image comprising a target object;
obtaining an auxiliary line by extracting semantic information from the original image, the auxiliary line comprising at least one of: an area boundary line of the target object and a part contour line of the target object;
obtaining a prediction result for a semantic line by inputting an image stitched from the auxiliary line and the original image to a predictive neural network, wherein the auxiliary line guides the predictive neural network to obtain the prediction result, the prediction result indicates a probability that a pixel in the original image is a pixel in the semantic line, and the semantic line is used for rendering the target object; and
obtaining the semantic line based on the prediction result for the semantic line.

17. The computer-readable storage medium of claim 16, wherein said obtaining an auxiliary line by extracting semantic information from the original image comprises:
obtaining coordinates of the auxiliary line by inputting the original image into a semantic recognition neural network; and
drawing the auxiliary line based on the coordinates of the auxiliary line.

18. The computer-readable storage medium of claim 16, wherein said obtaining a prediction result for a semantic line by inputting an image stitched from the auxiliary line and the original image to a predictive neural network, comprises:
inputting the image stitched from the auxiliary line and the original image to the predictive neural network; and
performing following steps using the predictive neural network:
determining coordinates of the auxiliary line and the semantic information of the auxiliary line based on the image stitched from the auxiliary line and the original image;
determining a distribution area of pixels for the semantic line within the original image based on the coordinates of the auxiliary line; and
determining a probability that the pixels in the distribution area are pixels in the semantic line based on the semantic information of the auxiliary line.

19. The computer-readable storage medium of claim 16, wherein the method further comprises:
adjusting a width of the semantic line so that widths of different lines in one or more semantic lines are consistent; and
obtaining a vectorized description parameter by vectorizing of the one or more semantic lines of the consistent widths, wherein the vectorized description parameter describes a geometric feature of the semantic line.

20. The computer-readable storage medium of claim 16, wherein an image of the target object is a human portrait;
in a case that the auxiliary line comprises the area boundary line, the area boundary line comprises at least one of: a boundary line of a body area, a boundary line of a hair area, and a boundary line of a clothing area; and/or
in a case that the auxiliary line comprises the part contour line, the part contour line comprises at least one of: a contour line of a face, a contour line of eyes, a contour line of a nose, and a contour line of a mouth.
